(19) United States
(12) Patent Application Publication
(10) Pub. No.: US 2013/0155918 A1
(43) Pub. Date: Jun. 20, 2013

(54) Techniques To Enhance Header Compression Efficiency And Enhance Mobile Node Security

(71) Applicants: Ajoy K. Singh, Round Lake, IL (US); Jay Jayapalan, Buffalo Grove, IL (US)

(72) Inventors: Ajoy K. Singh, Round Lake, IL (US); Jay Jayapalan, Buffalo Grove, IL (US)

(73) Assignee: Nokia Siemens Networks Oy

(21) Appl. No.: 13/330,823

(22) Filed: Dec. 20, 2011

(51) Int. Cl. H04W 4/00

(52) U.S. Cl. 370/310

(57) ABSTRACT

A method includes, in response to a determination a received packet has information in a header of the packet that if modified with other information would allow a subsequent header compression to compress the header to a larger degree than if the information was not modified, modifying the information with the other information. The method also includes compressing at least the header and transmitting the packet including the compressed header. Another method includes, in response to a determination a received packet has a sequential identification in a header of the packet, modifying the sequential identification to a random identification; and transmitting the packet to a core network. Apparatus and program products are also disclosed.

### TECHNICAL HELD

This invention relates generally to packet networks and, more specifically, relates to the delivery of information to a mobile node in wireless communication with a wireless network using packets.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The following abbreviations that may be found in the specification and/or the drawing figures are defined as follows:
AMR adaptive multi-rate
DL downlink (from base station to mobile node)
eNB or eNode B evolved Node B (base station in LTE)
GPRS general packet radio service
GTP GPRS tunneling protocol
ID identification
IETF Internet engineering task force
IP Internet protocol
L1 layer 1 (e.g., physical layer)
LTE long term evolution
MAC medium access control
MN mobile node
PDCP packet data convergence protocol
PDU protocol data unit
PER packet error rate
RLC radio link control
ROHC robust header compression
RTP real-time protocol
TBS transmission block size
TTI transmission time interval
UDP user datagram protocol
UL uplink (from mobile node to base station)
VOIP voice over IP
WB wideband
WIMAX worldwide interoperability for microwave access

The move towards all-IP and Voice over IP in wireless access networks (e.g., LTE, WIMAX, and the like) will dramatically increase overhead due to headers. For example, VOIP will be carried by the RTP/UDP/IP protocol suite. Assuming a cellular codec encoding rate of 12.2 kbps (kilobits per second), there is a payload of 34 bytes and a header overhead of 40 bytes for RTP/UDP/IPv4 (IP version four). This is an enormous overhead, and is clearly an unacceptable use of precious wireless bandwidth. This is especially true because, for VOIP, each client device will send one RTP/UDP/IP frame every 20 ms (milliseconds).

IETF has defined ROHC protocol (RFC 3095) to compress RTP/UDP/IPv4 headers down to one byte. However, a compressor implementing the ROHC protocol is unable to compress the RTP/UDP/IPv4 headers to one byte, especially when random IP-ID is encountered by the compressor. In the case of random IP-ID, the ROHC compressor will send un-compressed IP-ID to lower layers. In this case, ROHC compressor can only compress RTP/UDP/IPv4 headers down to five bytes when random IP-ID is used by IP packets and the UDP checksum is disabled.

It is possible to mitigate the affect of random IP-ID by ensuring that the client machine will always use sequential IP-ID. However, if the end-host is forced to use sequential IP-ID for better efficiency, the wireless device is vulnerable to following security attacks: OS (operating system) fingerprinting attack; idle scan; and estimate data volume or packet rate. These security issues are introduced when packets with sequential IP-ID are routed through the core network or the Internet.

Additionally, it is not possible to change the behavior of various clients in the Internet because most secure client machines are configured or will be configured to use random IP-ID to avoid these security issues.

### SUMMARY

In an exemplary embodiment, a method includes in response to a determination a received packet has information in a header of the packet that if modified with other information would allow a subsequent header compression to compress the header to a larger degree than if the information was not modified, modifying the information with the other information. The method also includes compressing at least the header and transmitting the packet comprising the compressed header.

In a further exemplary embodiment, an apparatus includes one or more processors and one or more memories including computer program code. The one or more memories and the computer program code configured to, with the one or more processors, cause the apparatus to perform at least the following: in response to a determination a received packet has information in a header of the packet that if modified with other information would allow a subsequent header compression to compress the header to a larger degree than if the information was not modified, modifying the information with the other information; compressing at least the header; and transmitting the packet comprising the compressed header.

In an additional exemplary embodiment, a computer program product is disclosed that includes a computer-readable medium bearing computer program code embodied therein for use with a computer. The computer program code includes: code for in response to a determination a received packet has information in a header of the packet that if modified with other information would allow a subsequent header compression to compress the header to a larger degree than if the information was not modified, modifying the information with the other information; code for compressing at least the header; and code for transmitting the packet comprising the compressed header.

In a further exemplary embodiment, an apparatus includes: means, responsive to a determination a received packet has information in a header of the packet that if modified with other information would allow a subsequent header compression to compress the header to a larger degree than if the information was not modified, for modifying the information with the other information; means for compressing at least the header; and means for transmitting the packet comprising the compressed header.

In another exemplary embodiment, a method includes, in response to a determination a received packet has a sequential identification in a header of the packet, modifying the sequential identification to a random identification; and transmitting the packet to a core network.

In a further exemplary embodiment, an apparatus includes one or more processors and one or more memories including computer program code. The one or more memories and the computer program code configured to, with the one or more processors, cause the apparatus to perform at least the following: in response to a determination a received packet has a sequential identification in a header of the packet, modifying the sequential identification to a random identification; and transmitting the packet to a core network.

In an additional exemplary embodiment, a computer program product is disclosed that includes a computer-readable medium bearing computer program code embodied therein for use with a computer. The computer program code includes: in response to a determination a received packet has a sequential identification in a header of the packet, modifying the sequential identification to a random identification; and transmitting the packet to a core network.

In a further exemplary embodiment, a disclosed apparatus includes means, responsive to a determination a received packet has a sequential identification in a header of the packet, for modifying the sequential identification to a random identification; and means for transmitting the packet to a core network.

### BRIEF DESCRIPTION OF THE DRAWINGS

In the attached Drawing Figures:

FIG. 1 illustrates a block diagram of an exemplary system in which the instant invention may be used;

FIG. 2 is a block diagram of a logical configuration of a mobile node and an eNB;

FIG. 3A is a table showing a result of having random IP ID fields in IPv4 headers on ROHC performance for a PER (packet error rate) of two percent;

FIG. 3B is a table illustrating performance benefits of an exemplary embodiment of the invention;

FIG. 4 is an example showing a packet header comprising RTP/UDP/IPv4 headers and their fields;

FIG. 5 is an example showing a packet header comprising RTP/UDP/IPv6 headers and their fields;

FIG. 6 is a flowchart of a method for enhancing header compression efficiency and enhancing mobile node security, performed by either a mobile node in uplink or an eNB in downlink;

FIG. 7 is a flowchart of a method for enhancing end-to-end reliability of a VoIP session and enhancing mobile node security, performed by an eNB in uplink;

FIG. 8 is a flowchart of another method for enhancing header compression efficiency and enhancing mobile node security, performed by an eNB in downlink; and

FIG. 9 shows an exemplary system using relay node(s).

### DETAILED DESCRIPTION OF THE DRAWINGS

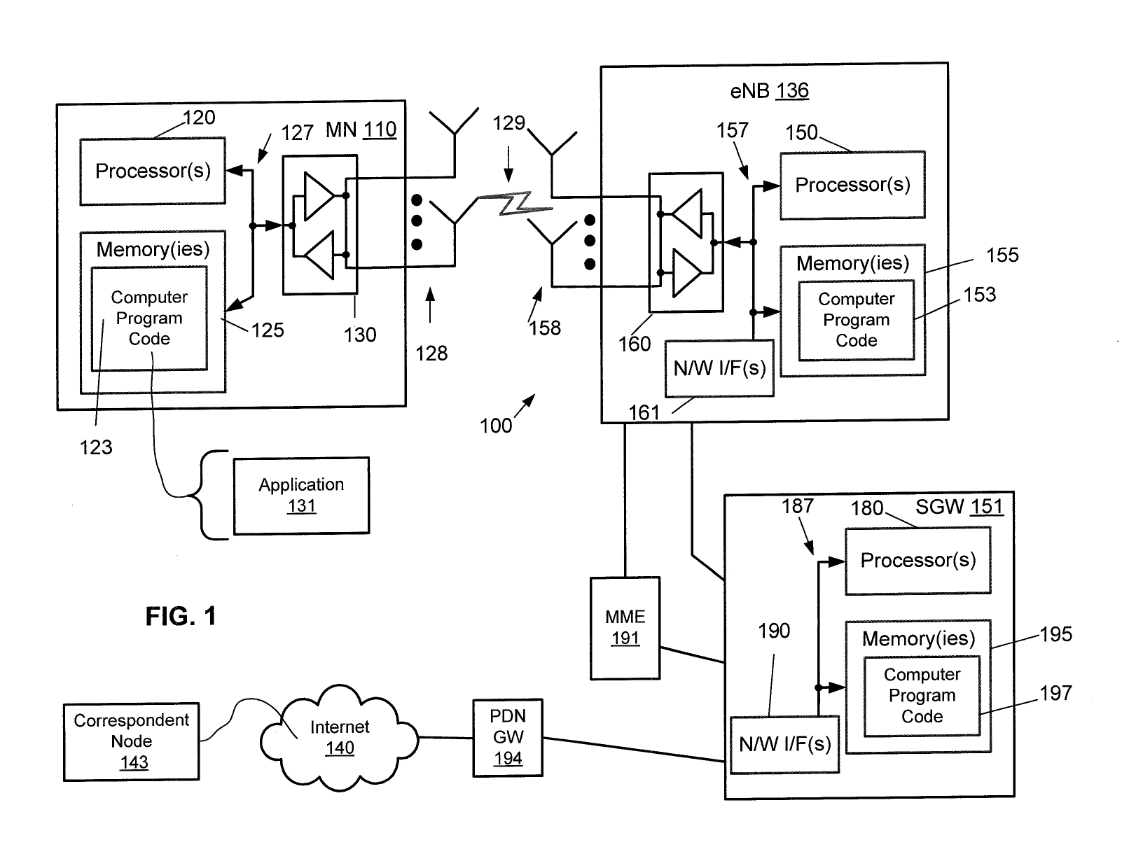

Before proceeding with additional description of exemplary techniques for enhancing header compression efficiency and enhancing mobile node security, exemplary systems are described in which the present invention might be used. For instance, FIG. 1 illustrates a block diagram of an exemplary system in which the instant invention may be used. In FIG. 1, a mobile node 110 is in wireless communication via wireless link 129 with the evolved Node B (eNB) 136, which is a base station in LTE. A network 100 comprises in this example the eNB 136, a serving gateway (SGW) 151, a mobility management entity (MME) 191, and a packet data network (PDN) gateway (GW) 194. The network 100 is coupled to another network (e.g., the Internet 140) via the PDN GW 194. A core network includes the SGW 151, the MME 191, and the PDN GW 194. A RAN includes the eNB 136, and a core network includes the SGW 151, MME 191, and PDN GW 194.

The MN 110 comprises one or more processors 120, one or more memories 125, and one or more transceivers 130, interconnected through one or more buses 127. The one or more transceivers 130 are connected to one or more antennas 128. The one or more memories 125 comprise computer program code 123. The one or more memories 125 and the computer program code 123 are configured, with the one or more processors 120, to cause the MN 110 to perform one or more of the operations described herein.

The eNB 136 comprises one or more processors 150, one or more memories 155, one or more network interfaces (N/W I/F(s)) 161, and one or more transceivers 160, interconnected through one or more buses 157. The one or more transceivers 160 are connected to one or more antennas 158. The one or more memories 155 comprise computer program code 153. The one or more memories 155 and the computer program code 153 are configured, with the one or more processors 150, to cause the eNB 136 to perform one or more of the operations described herein.

The SGW 151 comprises one or more processors 180, one or more memories 195, and one or more network interfaces (N/W I/F(s)) 190, interconnected through one or more buses 187. The one or more memories 195 comprise computer program code 197. The one or more memories 195 and the computer program code 197 are configured, with the one or more processors 180, to cause the SGW 151 to perform one or more of the operations described herein.

The network interfaces 161, 190 provide access to other elements in the network 100, e.g., using various interfaces as is known. For example, the interface between the eNB 136 and the SGW 151 may include an S1 interface, as might the interface between the eNB 136 and the MME 191. The interface between the MME 191 and the SGW 151 may include an S11 interface, and the interface between the PDN GW 194 and the SGW 151 might include S5/S8 interfaces.

In an example, the application 131, implemented as part of computer program code 123 of the MN 110, is in communication with correspondent node 143 in the Internet 140. IP packets (not shown in FIG. 1) are exchanged between the application 131 and the correspondent node 143.

The various embodiments of the MN 110 can include, but are not limited to, cellular telephones, smart phones, relay node, M2M devices, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. The mobile node 110 may also be referred to by other names, such as user equipment or mobile device.

The memories 125, 155, and 195 may be of any type suitable to the local technical environment and may be implemented using any suitable data storage technology, such as semiconductor based memory devices, magnetic memory devices and systems, optical memory devices and systems, fixed memory and removable memory. The processors 120, 150, and 180 may be of any type suitable to the local technical environment, and may include one or more of general purpose computers, special purpose computers, microprocessors, digital signal processors (DSPs) and processors based on a multi-core processor architecture, as non limiting examples.

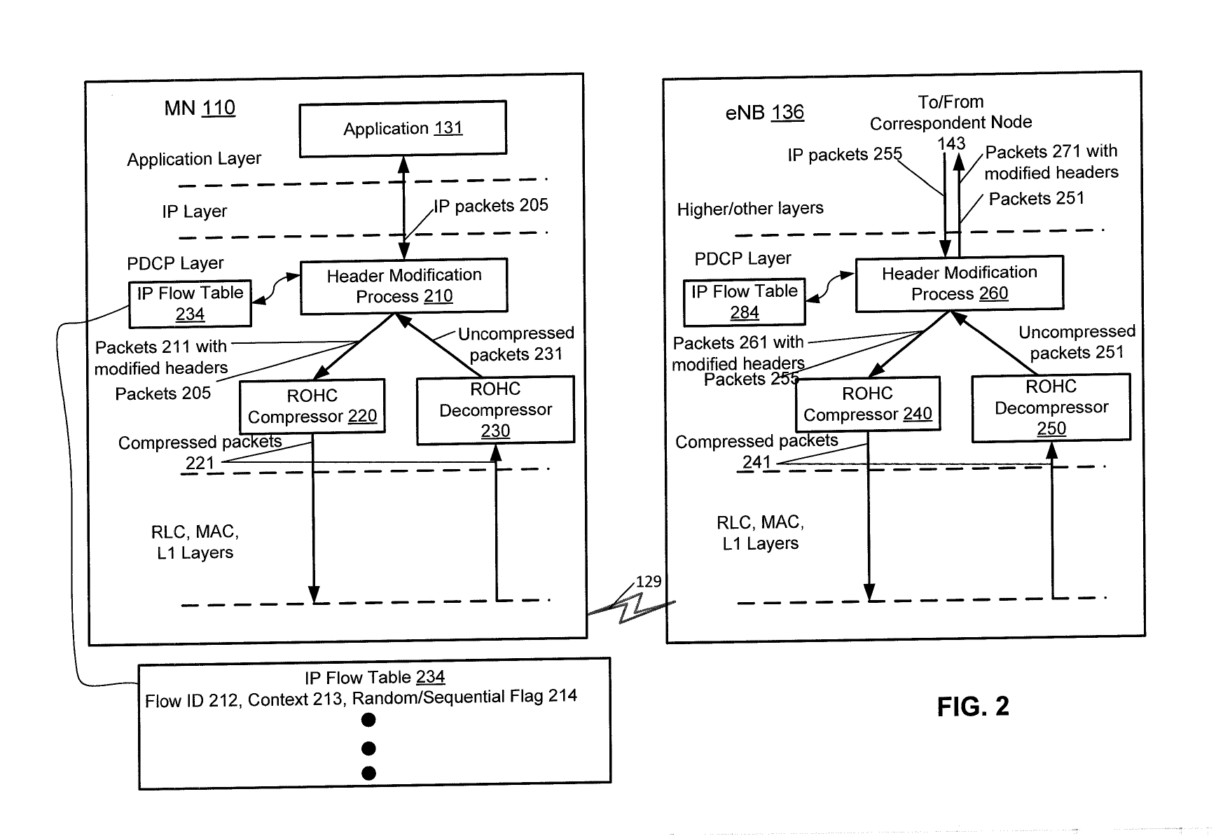

Turning to FIG. 2, a block diagram is shown of a logical configuration of a mobile node 110 and an eNB 136. The MN 110 includes an application layer, IP layer, PDCP layer, an RLC layer, a MAC layer, and an L1 layer. The eNB 136 includes higher/other layers (e.g., a relay layer), a PDCP layer, an RLC layer, a MAC layer, and an L1 layer. The recited layers are layers of a user plane protocol architecture/stack. The layers are implemented at least in part on the corresponding computer program code 123, 153.

On the MN 110, the application 131 is implemented at least in part in the application layer. IP packets 205 are communicated between the application 131 and the correspondent node 143, after passing through layers of the MN 110 and the eNB 136 (and other core network elements not shown in FIG. 2). The header modification process 210 is a process that performs certain modification to IP headers (to create packets 211 with modified headers) or to pass packets 205 without modification in accordance with techniques described in more detail below. The header modification process 210 uses the IP flow table 234. On the uplink, the ROHC compressor 220 creates compressed packets 221 based on the packets 211, 205. These compressed packets 221 are sent via lower layers (RLC, MAC, and L1 layers) through the link 129 to the eNB 136.

In the eNB 136, the L1, MAC and RLC layers produce compressed packets 241. The ROHC decompressor 250 operates on the compressed packets 241 to create uncompressed packets 251. The header modification process 260 is a process that performs certain operations as described in more detail below in order to create packets 271 with modified headers or pass IP packets 251. The header modification process 260 uses the IP flow table 284.

Concerning downlink, the IP packets 255 received from the correspondent node 143 are operated on by the header modification process 260 using operations described below to create either packets 261 with modified headers or pass packets 255. The ROHC compressor 240 creates compressed packets 241 based on the packets 261, 255. These compressed packets 241 are sent via lower layers (RLC, MAC, and L1 layers) through the link 129 to the MN 110.

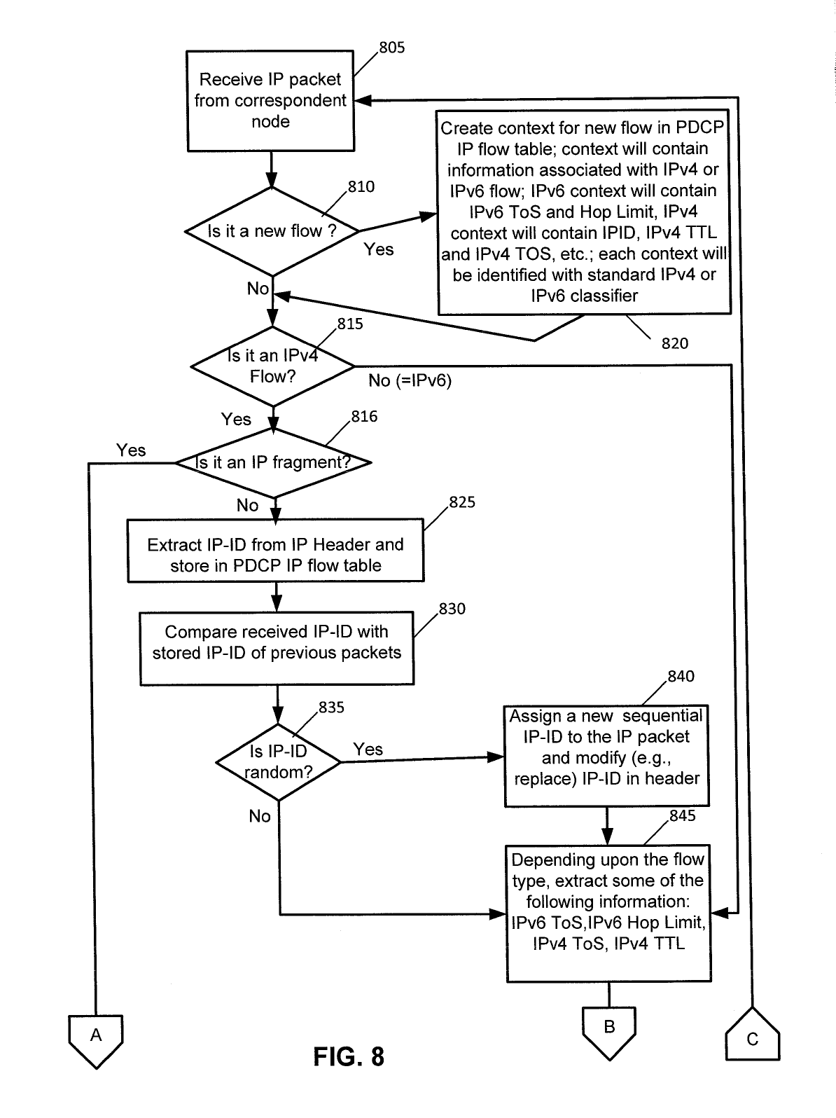

In the MN 110, the L1, MAC and RLC layers produce compressed packets 221. The ROHC decompressor 230 operates on the compressed packets 221 to create uncompressed packets 231. The header modification process 210 in downlink may or may not perform operations on the uncompressed packets 231. For instance, if the mobile node 110 is a handset, process 210 will not perform any additional processing. However, in cases where mobile node 110 acts as a router, this function can convert sequential IP-ID to random IP-ID as described, e.g., in FIG. 7.

The header modification process 210/260 are used herein merely for ease of exposition. The operations disclosed herein and attributed to the header modification process 210/260 may be performed by other entities (e.g., PDCP layers), and there may not be an actual process 210/260 dedicated to these operations.

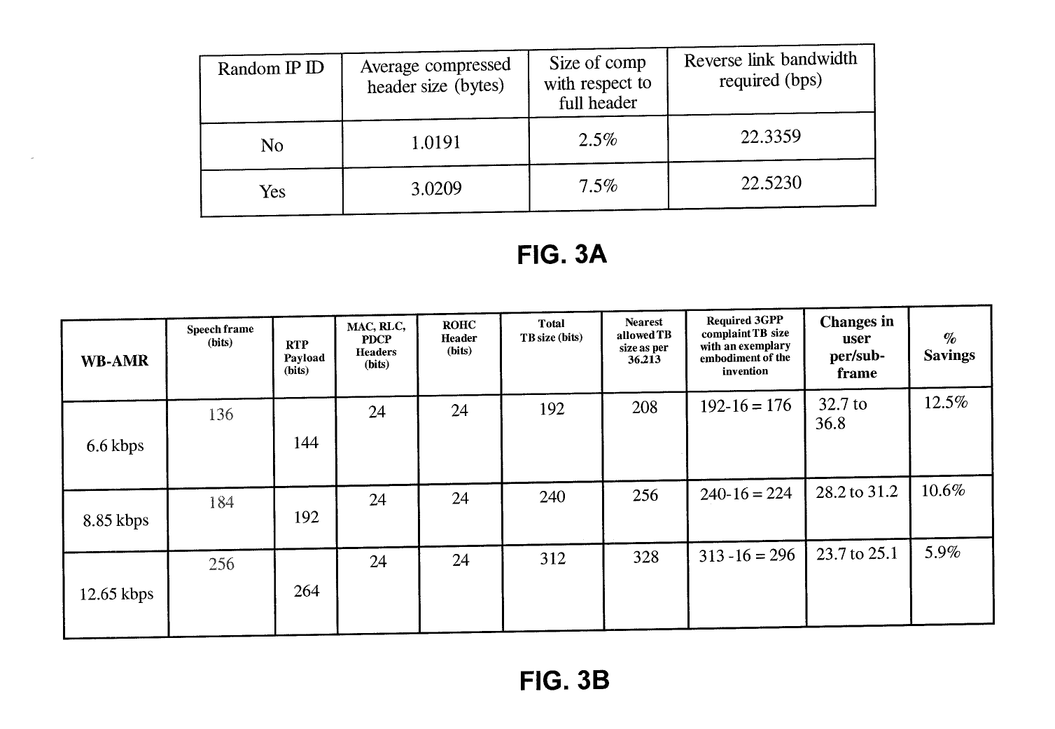

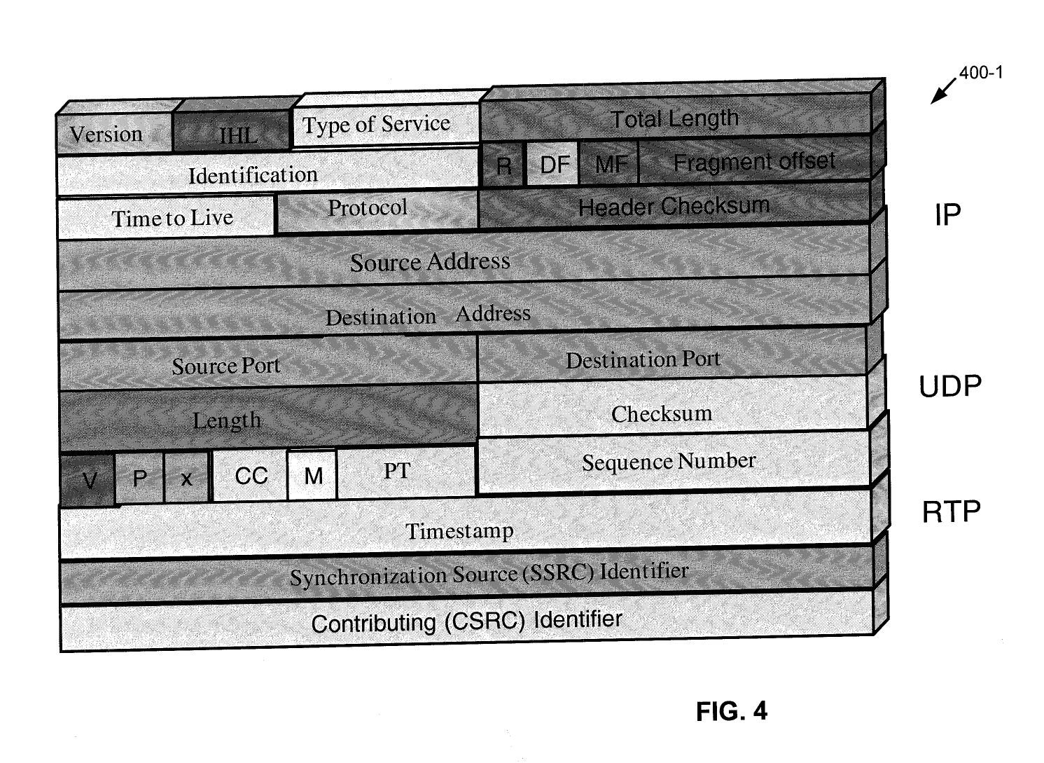

Returning to problems with current compression of headers, the table shown in FIG. 3A shows a result of having random IP-IDs in the IP-ID field in the IPv4 headers on ROHC performance for a PER of two percent. This figure also uses RTP/UDP/IPv4 header compression efficiency with a disabled UDP checksum. It can be seen that the average compressed header size increases by approximately two bytes, from 1.0191 to 3.0209. The IP-ID field in IPv4 (IP version four) is two bytes long and when this field is random, the ROHC compressor 220, 240 sends the field without any modification. In the case of tunneled IPv4-in-IPv4 headers, a random IP-ID can add up to four bytes to the average size of a compressed header. If compression of IP-ID field and UDP checksum is not allowed, it is very likely that full rate 12.2 Kbps AMR data will not be accommodated in a TBS size of 296 bits, and a voice PDU will have to be sent in next available TBS value, which is 328 bits. The simulation results shown in FIG. 3B predict the use of TBS size of 328 bits instead of 296 bits will change capacity/sub-frame from 23.7 to 25.1 (bits per second per subframe), which is a degradation of 5.9 percent. The simulation results predict that at data rate 8.85 Kbps, savings can be 10.6% (percent) and at 6.6 Kbps data rate the savings can be 12.5% (percent).

Also, IPv4-in-IPv4 tunneling or TTI bundling can further aggravate this issue. TTI bundling can be deployed to extend VoIP coverage, and therefore should be taken into consideration too.

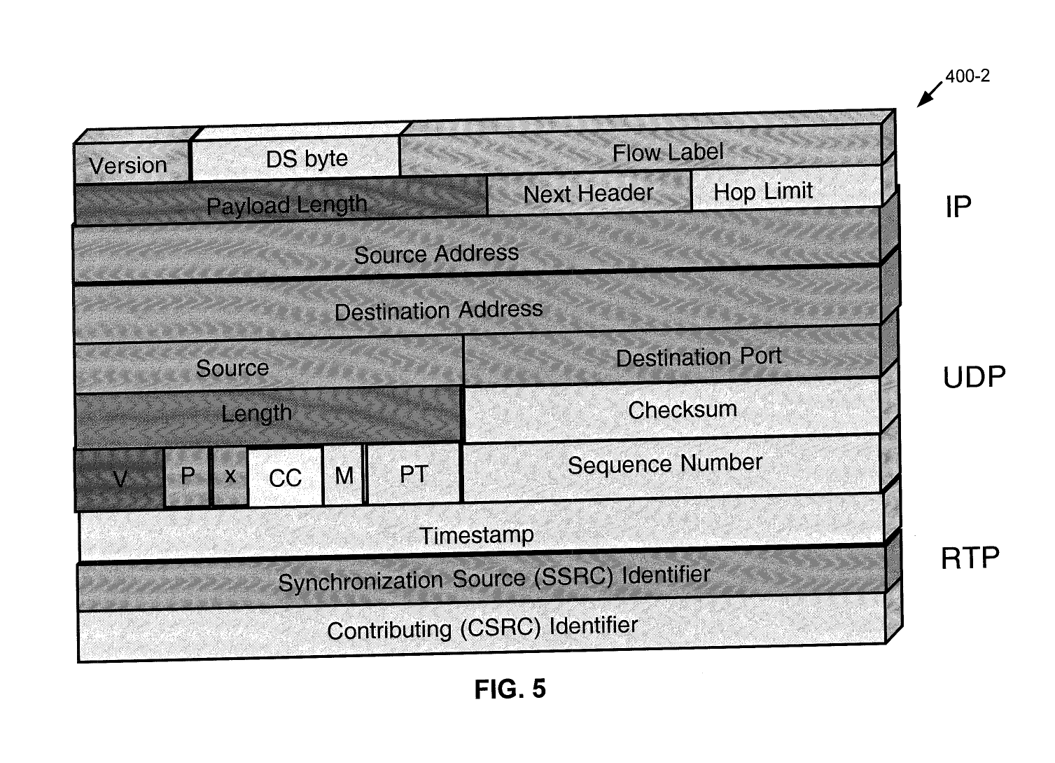

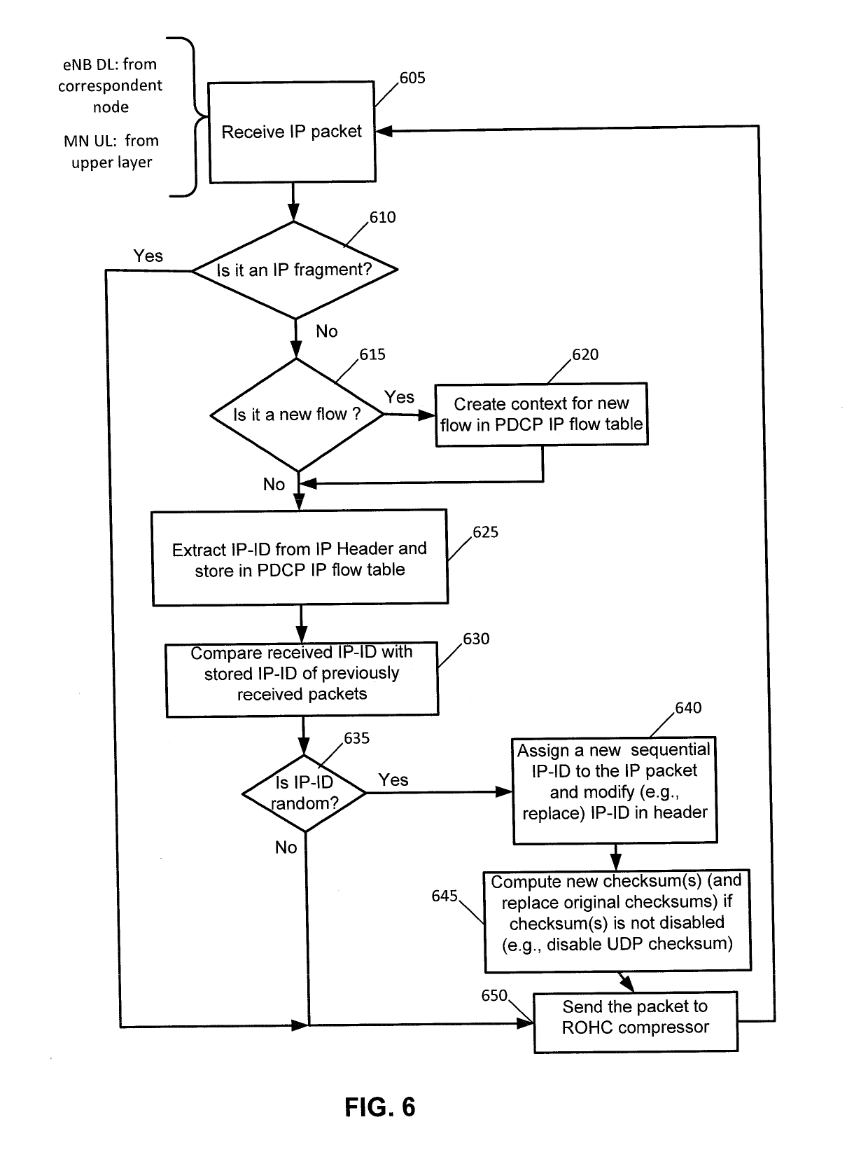

FIGS. 4 and 5 are used to illustrated headers and their fields and whether header fields change frequently. FIG. 4 is an example showing a packet header 400-1 comprising RTP/UDP/IPv4 headers and their fields. In FIG. 4, the following acronyms are used: R stands for “Reserved”; DF stands for “Don't Fragment”; MF stands for “More Fragment”; V stands for “Version”; P stands for “Padding”; X stands for “Extension”; CC stands for “CSRC Count”; M stands for “Marker”; and PT stands for “Payload Type”. The Identification field is typically 16 bits and is used to identify the fragments of one datagram from those of another. The originating protocol module of an internet datagram sets the identification field to a value that should be unique for that source-destination pair and protocol for the time the datagram will be active in the internet system. However, there are a number of systems setting the Identification field based on pseudo-random numbers. See, e.g., section 3.5.2.1 of Internet Engineering Task Force (IETF), Request for Comments: 6274, “Security Assessment of the Internet Protocol Version 4” (July 2011). The originating protocol module of a complete datagram clears the MF bit to zero and the Fragment Offset field to zero. The DF is a bit that controls the fragmentation of the datagram: 0 (zero) indicates fragment if necessary; 1 (one) indicates do not fragment. The MF is a bit that indicates if the datagram contains additional fragments: 0 (zero) indicates this packet is the last fragment; 1 (one) indicates additional packets (fragments) follow this fragment. The fragment offset is 13 bits and is used to direct the reassembly of a fragmented datagram.

The items that change with some frequency are the following fields: type of service, IP-ID (shown as “Identification”), time to live, checksum, CC, M, PT, sequence number, timestamp, and CSRC identifier.

FIG. 5 is an example showing a packet header 400-2 comprising RTP/UDP/IPv6 (IPV6 means IP version 6) headers and their fields. In FIG. 5, the following acronyms are used: V stands for “Version”; P stands for “Padding”; X stands for “Extension”; CC stands for “CSRC Count”; M stands for “Marker”; and PT stands for “Payload Type”.

Of particular interest is the IP-ID field shown in packet header 400-1. As stated above, having a random IP-ID in the IP-ID field reduces the compression by a ROHC compressor 220, 240, since the ROHC compressor 220, 240 forwards a packet 205, 255 with a random IP-ID without compressing IP-ID. This disclosure proposes a solution that will help enhance header compression efficiency and at the same time enhance end-to-end security of a mobile node from the aforementioned security attacks. That is, exemplary embodiments herein propose that an edge node of a wireless access network (e.g., eNodeB 136 or MN 110) monitor IP-IDs of downlink/uplink IP packets 105, 255 associated with various IP flows established between mobile nodes 110 and correspondent nodes 143 for which header compression is enabled over the radio link 129 to determine if a particular flow is using random IP-ID or not. If the edge node identifies that a particular flow is using random IP-ID, the edge node will modify the random IP-ID to sequential IP-ID before sending the modified packets 211, 261 to the ROHC compressor 220, 240.

In addition to the IP-ID field, there are other possible areas where compression efficiency can be improved. The items that change with some frequency are the following fields: DS (differentiated services) type, IPv6 hop limit, checksum, CC, M, PT, sequence number, timestamp, CSRC identifier, IPv4 Type Of Service (TOS), and IPv4 Time To Live (TTL). In the downlink, it is possible some of above fields can also change in a given data flow while packets are routed from a correspondent node to the eNodeB. For instance, the value of TTL or IPv6 Hop count will depend upon how an IP packet is routed from correspondent node to eNodeB. Depending upon number of hops traveled, IPv4 TTL (or IPv6 Hop Limit) of each packet might have different values. IPv4 TOS (or IPv6 Traffic class) can be modified by intermediate routers for quality of service reasons. It is noted that a correspondent node is an endpoint in a communication between two nodes, typically a MN and a node on a network such as the Internet.

Hence, it is suggested that in addition to IPv4 IP-ID, the eNodeB will also monitor above the parameters and modify changed values to previous values to avoid any impact on header compression performance. This is suitable to do because changing hop count and TOS will not have any impact on behavior of the mobile node 110.

Concerning modification of IP-ID, to avoid functional impact on end-to-end data transfer:

1) The eNodeB/MN lower layer (e.g., PDCP layer) will modify the IP-ID to sequential only if IP packet 205, 255 is not fragmented. The IP-ID of fragmented IP packets will be sent unchanged.

2) If required, eNodeB/MN lower layer (e.g., PDCP layer) will re-compute checksums after modifying the IP-ID to ensure that checksums associated with IP packets are valid even after the IP-ID is modified.

To enhance security of mobile device, the eNodeB 136 will change the sequential IP-ID of uplink packets (e.g., 251) to random IP-ID before sending uplink packets 271 to the core network. After changing the IP-ID, the eNodeB 136 will also re-compute UDP/TCP checksum if required.

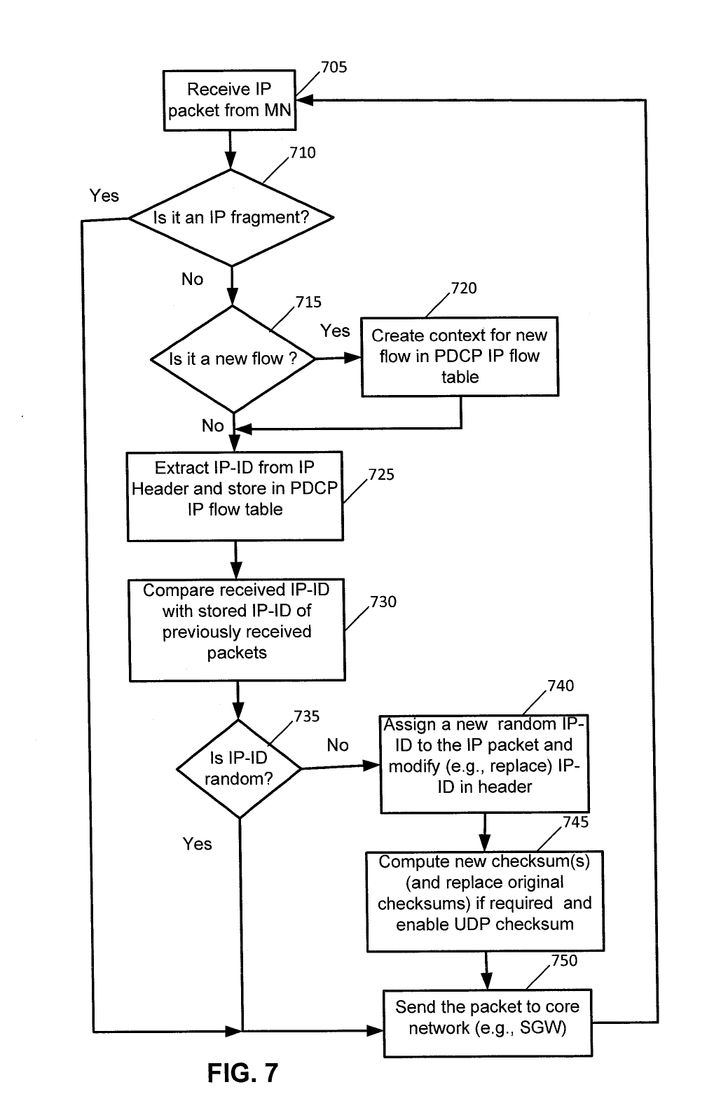

Turning now to FIG. 6, a flowchart is shown of a method for enhancing header compression efficiency. The method shown in FIG. 6 may be performed either by a mobile node 110 in uplink (e.g., by header modification process 210) or by an eNB 136 in downlink (e.g., by header modification process 260). In block 605, therefore, the header modification process 210/260 receives a packet from an upper layer (e.g., IP layer) in the MN 110 in uplink or from a correspondent node in the eNB 136 in downlink.

It is noted that additional processing may take place, e.g., by the PDCP layer prior to block 610. For instance, the PDCP layer would receive packets 205/255 sent by upper layers or a correspondent node and then classify the received packets 205/255 based on SRC (source) IP address, DEST (destination) IP address, SRC port and DEST port, protocol type, etc. Alternatively, a PDCP layer can use LTE-specific information for classification purposes as well. For example, in LTE, RTP/UDP/IP packets will be associated with a QCI 1 (QoS, quality of service, class identifier) dedicated bearer, therefore, the eNodeB 136 (for instance) can also use GTP tunnel ID or logical channel associated with a PDCP flow for classification purposes. Classification may be useful, e.g., to determine whether a flow is a new flow or a previously seen flow.

In block 610, the header modification process 210/260 determines if the received IP packet 205/255 is an IP fragment (e.g., information broken into multiple packets). The header modification process 210/260 can identify if the packet is fragmented or not by monitoring a combination of, e.g., the MF flag and Fragment offset of IPv4 header. If the received IP packet 205/255 is an IP fragment (block 610=Yes), the header modification process 210/260 sends the packet to the ROHC compressor 220/240 unaltered (e.g., as packet 205/255) in block 650.

If the received IP packet 205/255 is not an IP fragment (block 610=No), the header modification process 210/260 determines if the received IP packet 205/255 is part of a new flow in block 615. If so (block 615=Yes), the header modification process 210/260 creates context (block 620) for a new flow in a PDCP IP flow table 234/284. The context is shown in FIG. 2 as context 213. It is assumed in an example that each flow will have a flow ID 212, a context 213, and a random/sequential flag 214. The flow ID 212 is a way to access the table for a particular flow, and such an ID 212 may not be used in certain implementations (e.g., if the context 213 also defines a flow). If not (block 615=No), the header modification process 210/260 extracts the IP-ID from the IP header (e.g., part of header 400) and stores the IP-ID in the PDCP IP flow table 234/284 (block 625).

In block 630, the header modification process 210/260 compares a received IP-ID of the currently received packet with stored IP-IDs of previously received packets. In block 635, the header modification process 210/260 determines whether the IP-ID is random. For instance, if a comparison of the current IP-ID with the (immediately) previous IP-ID is anything other than one number's difference, the IP-ID is assumed to be random. Block 635 may also adjust the flag 214 to indicate whether this flow uses random or sequential IP-IDs. If the IP-ID is not random (block 635=No) (i.e., is sequential), the header modification process 210/260 sends the unmodified received packet 205/255 to the ROHC compressor 220/240.

If the IP-ID is determined to be random (block 635=Yes), in block 640, the header modification process 210/260 assigns a new sequential IP-ID to the IP packet 205/255 (it is noted the PDCP IP flow table 234/284 may be updated indicating that a given IP flow uses random IP-ID, via, e.g., the flag 214) and in block 645, the header modification process 210/260 computes new checksum(s) if the checksum(s) is/are not disabled. It is noted that if the flag 214 is used, once a flow is determined to be using random or sequential IP-IDs, then blocks 630 and 635 can test the flag 214 instead of comparing received and stored IP-IDs. Blocks 640 and 645 create packets 211/261 having modified headers. Regarding checksums, the UDP checksum should be recomputed in block 645 if the checksum is not set to zero. A UDP checksum is enabled if the checksum has a value that is not zero (zero indicates the UDP checksum is disabled). However, the IP checksum should be computed for block 645. Another option shown in block 645 is to disable the UDP checksum, which should allow additional compression relative to if the UDP checksum was enabled.

In block 650, the packets 211/261 with modified headers are sent to the ROHC compressor 220/240. The ROHC compressor 220/240 forwards the compressed packet 221/241 to the lower layers and the corresponding device (e.g., MN 110 or eNB 136) transmits the packet using link 129. After block 650, the method continues in block 605.

Referring now to FIG. 7, a flowchart is shown of a method for enhancing end-to-end reliability of packet session and enhancing mobile node security, performed by an eNB 136 in uplink. In block 705, therefore, the header modification process 260 receives a packet from the MN 110 (e.g., receives an uncompressed packet 251 from the ROHC decompressor 250).

It is noted that additional processing may take place, e.g., by the PDCP layer prior to block 710. For instance, the PDCP layer would receive packets 251 sent by ROHC de-compressor 250 then classify the received packets 251 based on SRC (source) IP address, DEST (destination) IP address, SRC port and DEST port, protocol type, etc. Alternatively, PDCP layer can use LTE-specific information for classification purposes as well. For example, in LTE, RTP/UDP/IP packets will be associated with a QCI 1 dedicated bearer, therefore, the eNodeB 136 (for instance) can also use a logical channel associated with a PDCP flow for classification purposes.

In block 710, the header modification process 260 determines if the received IP packet 251 is an IP fragment. The header modification process 260 can identify if the packet is fragmented or not by monitoring a combination of MF flag and Fragment offset of IPv4 header. If the received IP packet 251 is an IP fragment (block 710=Yes), the header modification process 260 sends the packet to the core network unaltered (e.g., as packet 251) in block 750.

If the received IP packet 251 is not an IP fragment (block 710=No), the header modification process 260 determines if the received IP packet 251 is part of a new flow in block 715. If so (block 715=Yes), the header modification process 260 creates (block 720) context 213 (and possibly a corresponding flow ID 212) for a new flow in a PDCP IP flow table 284. If not (block 715=No), the header modification process 260 extracts the IP-ID from the IP header (e.g., part of header 400) and stores the IP-ID in the PDCP IP flow table 284 (block 725).

In block 730, the header modification process 260 compares the received IP-ID with stored IP-ID of previously received packets for this flow. In block 735, the header modification process 260 determines whether the IP-ID is random. Block 735 may also adjust the flag 214 to indicate the corresponding flow is using random or sequential IP-IDs. If the IP-ID is random (block 735=Yes), the header modification process 260 sends the unmodified received packet 251 to the core network.

If the IP-ID is determined not to be random (block 735=Yes), in block 740, the header modification process 260 assigns a new random IP-ID to the IP packet 251 and in block 745, the header modification process 260 computes new checksum(s) (and replaces original checksum(s), if any) if required and enables UDP checksum (e.g., by placing a non-zero UDP checksum in the corresponding field). Blocks 740 and 745 create packets 271 having modified headers. In block 750, the packets 271 with modified headers are sent to the core network. After block 750, the method continues in block 705.

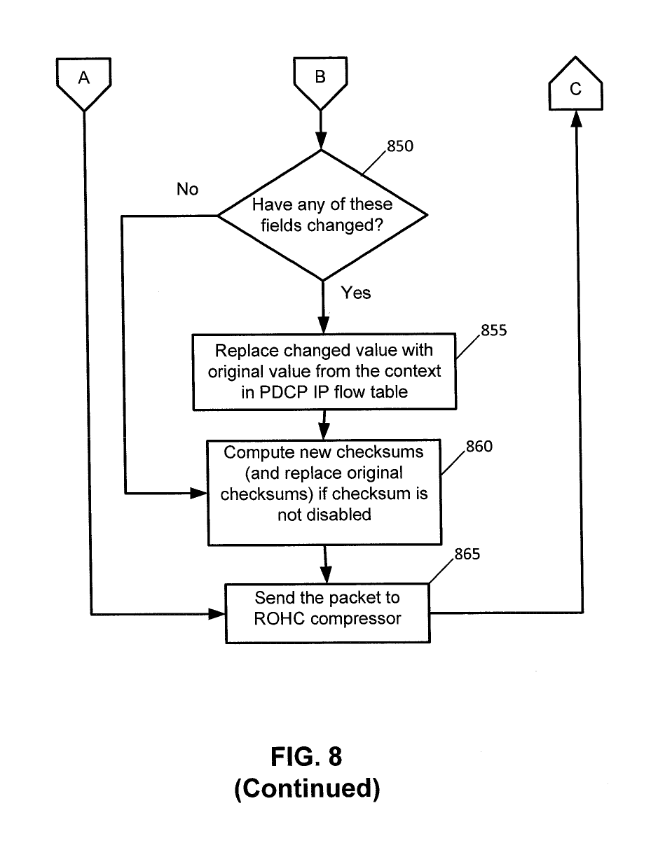

FIG. 8 is a flowchart of another method for enhancing header compression efficiency, performed by an eNB in downlink. In this example, entries other than the IP-ID in a header 400 may be examined and modified. In block 805, an IP packet 255 is received from a correspondent node 143. As already described above, it is noted that additional processing may take place, e.g., by the PDCP layer prior to block 810.

In block 810, the header modification process 260 determines whether the flow is a new flow. If so (block 810=Yes), the header modification process 260 creates (block 820) context 213 (and perhaps a flow ID 212) for a new flow in a PDCP IP flow table 284. The context 213 contains information associated with the IPv4 or IPv6 flow. The IPv6 context will contain IPv6 ToS and Hop Limit, and the IPv4 context will contain IP-ID, IPv4 TTL and IPv4 TOS, etc. Each context 213 will be identified with a standard IPv4 or IPv6 classifier. If the flow is not a new flow (block 810=no) or block 820 was performed, in block 815, the header modification process 260 determines if the flow is an IPv4 flow. This can be performed using the version field of IP header. If the version indicates packet is an IPv6 packet (block 815=No), the method proceeds in block 845. If the flow is an IPv4 flow (block 815=Yes), the method proceeds in block 816.

In block 816, the header modification process 260 determines whether the received IP packet 255 is an IP fragment. The header modification process 260 can identify if the packet is fragmented or not through techniques already described above. If the received IP packet 255 is an IP fragment (block 816=Yes), the header modification process 260 sends the packet to the ROHC compressor 240 unaltered (e.g., as packet 255) in block 865. If the received IP packet 255 is not an IP fragment (block 816=No), the header modification process 260 extracts the IP-ID from the IP header (e.g., part of header 400) and stores the IP-ID in the PDCP IP flow table 284 (block 825). In block 830, the header modification process 260 compares received IP-ID with stored IP-ID of previous packets. In block 835, the header modification process 260 determines whether the IP-ID is random. Block 835 may also set an appropriate value for the flag 214. If the IP-ID is determined to be random (block 835=Yes), in block 840, the header modification process 260 assigns a new sequential IP-ID to the IP packet 255. If the IP-ID is not random (block 835=No), block 845 is performed. In block 845, depending upon the flow type, the header modification process 260 extracts some of the following information: IPv6 ToS, IPv6 Hop Limit, IPv4 ToS, and/or IPv4 TTL. IPv6 ToS and IPv6 Hop Limit are part of IPv6 header whereas IPv4 ToS IPv4 TTL are part of IPv4 header. Block 845 may involve another check to determine if a flow is IPv4 or IPv6. This can be performed using the version field of IP header. If the version field indicates packet is an IPv4 packet, IPv4 ToS and IPv4 TTL will be processed, otherwise IPv6 ToS and IPv6 Hop Limit will be processed.

In block 850, the header modification process 260 determines (e.g., using the PDCP IP flow table 284) if any of these fields have changed, e.g., since the immediately preceding packet or based on a stored value in the PDCP IP flow table 284 (e.g., in the context 213). If none of these fields has changed (block 850=No), the method proceeds to block 860. If any one or more of the fields have changed (block 850=Yes), in block 855, the header modification process 260 replaces the changed value with original value from the context in the PDCP IP flow table 284.

In block 860, the header modification process 260 computes new checksum(s) (and, e.g., replaces original checksums with computed checksums) if the checksum(s) is/are not disabled. Blocks 840-860 create packets 261 having modified headers. In block 865, the packet 261 with modified headers is sent to the ROHC compressor 240, which forwards the packet as a compressed packet 241 to lower layers for transmission via the link 129 to the MN 110. After block 865, the method continues in block 805.

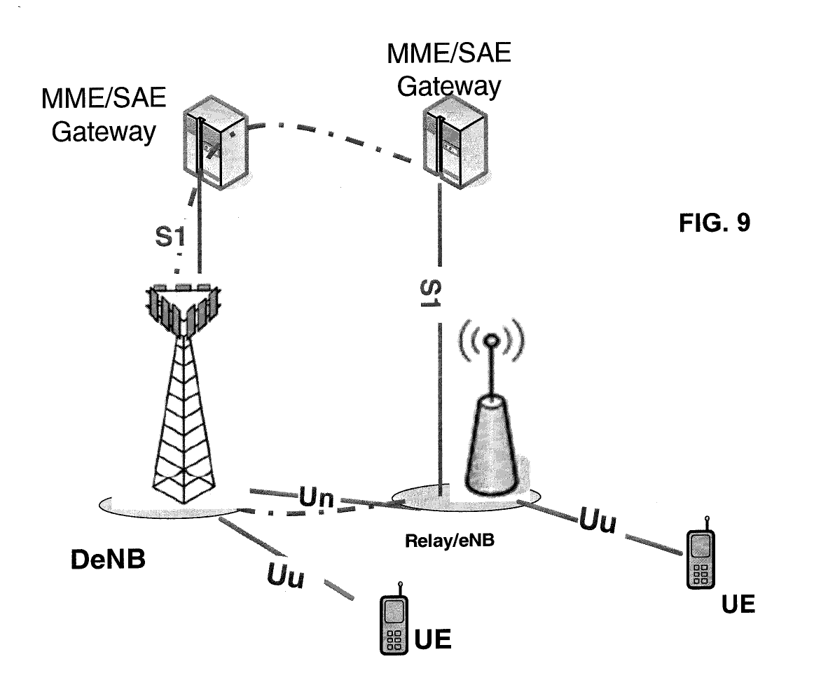

Referring now to FIG. 9, FIG. 9 shows an exemplary system using relay nodes. The techniques presented herein may also be used in such systems. This figure shows an LTE-A relay architecture having a proxy S1 (and X2) via the DeNB (donor eNB). From the MME and a neighbor eNB, it appears as if the UE is connected to the DeNB. From the RAN, it appears as if the RAN is talking to the MME for S1-C, to a neighbor eNB for X2 and to S-GW for S1-U. The interfaces S1 and X2 are forwarded by the DeNB (proxy function) to the RN. The Un interface between DeNB and RN has being standardized and this interface reuses MAC/RLC/PDCP/RRC from Uu. In an exemplary embodiment, the PDCP layer of the relay node (shown as “relay/eNB”) can implement the exemplary embodiments presented herein.

Thus, as has been described at least in part above, the following exemplary embodiments have been disclosed. In an exemplary embodiment, a method is disclosed that optimizes PDCP for improving the efficiency of wireless link and enhancing security of wireless devices. In an exemplary embodiment, in response to the IP-ID of a received packet being random and the received IP packet is not part of an IP fragment, a PDCP layer (e.g., process such as header modification process 210/260) replaces a random IP-ID with sequential IP-ID, re-computes a higher layer checksum if such checksum is not disabled before compressing the header using ROHC. In an additional exemplary embodiment, to further achieve additional compression efficiency gain, a PDCP layer can determine to disable UDP checksum as soon an IP-ID is converted from random IP-ID to sequential IP-ID.

In another exemplary embodiment, if an RTP/UDP/IP packet is tunneled inside another IPv4 packet, the PDCP layer will change random IP-IDs of both inner and outer IPv4 headers to sequential before compressing header using ROHC. In a further exemplary embodiment, to enhance security of a mobile node 110, an eNodeB 136 will change sequential IP-ID of uplink packets to random IP-ID before sending uplink packets to the core network. After changing the IP-ID, eNodeB will also re-compute UDP/TCP checksum. To further enhance end-to-end reliability of VoIP session, in a further exemplary embodiment, the eNodeB 136 will enable the UDP checksum after changing the IP-ID from sequential to random so that RTP/UDP/IP packets will have additional built-in error detection mechanism while the packets are routed through core networks to a correspondent node 143.

The examples above may be applied, e.g., to LTE PDCP layer or can be applied to any 3G/4G/4G+ (third generation, fourth generation, fourth or higher generation) wireless access networks. For example, the embodiments presented above can be applied to UMTS (universal mobile telecommunications system)/HSPA (high speed packet access)/CDMA (code division multiple access) and/or WIMAX. In UMTS/HSPA, ROHC is implemented by RNC and MN PDCP layers. In CDMA, ROHC is implemented by PDSN (packet data serving node) and MN PPP (point-to-point protocol) layers. In WIMAX, ROHC can be implemented on ASN-GW (access service network-gateway) (or BTS MAC, base transceiver station medium access control) layer and MN MAC layer.

A technical effect of these teachings is that they enable improved compression of packet headers. A further technical effect is the compression can be performed while still enhancing mobile node security.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memory 125, 155 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
in response to a determination a received packet has information in a header of the packet that if modified with other information would allow a subsequent header compression to compress the header to a larger degree than if the information was not modified, modifying the information with the other information;
compressing at least the header; and
transmitting the packet comprising the compressed header.

2. The method of claim 1, further comprising, prior to compressing, computing, based on modification of the random identification to the sequential identification, one or more new checksums in the header of the packet and replacing one or more original checksums in the header with the computed one or more checksums.

3. The method of claim 1, further comprising determining a user datagram checksum in the received packet is enabled and disabling the user data protocol checksum.

4. The method of claim 1, wherein the information is a random identification in the header of the packet, and wherein modifying further comprises modifying the random identification to a sequential identification.

5. The method of claim 4, further comprising determining the received packet has a random identification in the header of the packet at least by comparing a current value of an identification field of the packet with at least one value of the identification field from at least one previously received packet.

6. The method of claim 4, wherein the method further comprises receiving a series of packets and performing the modifying, compressing, and transmitting for the series of packets, and wherein the modifying is performed to replace random values in an identification field of the packet with values from a series of sequential values.

7. The method of claim 4, wherein the modifying is performed only in response to a determination the received packet is not a fragmented packet.

8. The method of claim 4, wherein the packet comprises a plurality of identifications and the modifying and compressing is performed for each of the plurality of identifications.

9. The method of claim 4, further comprising in response to a determination the received packet has a sequential identification in the header of the packet, performing the compressing without performing the modifying.

10. The method of claim 1:
wherein the method further comprises:
determining a flow type for a flow to which the packet belongs;
depending on the flow type, extracting corresponding information from fields of the header of the packet; and
determining whether any of the corresponding information has changed relative to one or more previously received packets; and
wherein modifying further comprises, responsive to a determination any of the corresponding information has changed, replacing any changed corresponding information with original information for a field, the original information previously determined using the one or more previously received packets.

11. The method of claim 10, further comprising computing, based on replacement of the additional information with the original information, one or more new checksums and replacing one or more original checksums in the header with the computed one or more checksums.

12. The method of claim 10, wherein the additional information comprises one or more of the following: Internet protocol version six (IPv6) type of service, IPv6 hop limit, Internet protocol version four (IPv4) type of service, or IPv4 time to live.

13. The method of claim 10, wherein the flow type comprises either a first flow type or a second flow type, and wherein extracting further comprises for the first flow type extracting a random identification in an identification field of the header, and wherein modifying further comprises modifying the random identification to a sequential identification.

14. (canceled)

15. (canceled)

16. The method of claim 1, wherein the packet is formatted at least in part using an Internet protocol.

17.-21. (canceled)

22. A method, comprising:
in response to a determination a received packet has a sequential identification in a header of the packet, modifying the sequential identification to a random identification; and
transmitting the packet to a core network.

23. The method of claim 22, further comprising, computing, based on modification of the sequential identification to the random identification, one or more new checksums in the header of the packet and replacing one or more original checksums in the header with the computed one or more checksums.

24. The method of claim 23, wherein at least one of the one or more checksums is a user datagram protocol checksum and wherein the method further comprises enabling a user data protocol checksum.

25. The method of claim 22, further comprising determining the received packet has a sequential identification in the header of the packet at least by comparing a current value of an identification field of the packet with at least one value of the identification field from at least one previously received packet.

26. The method of claim 22, wherein the method further comprises receiving a series of packets and performing the modifying, compressing, and transmitting for the series of packets, and wherein the modifying is performed to replace random values in an identification field of the packet with values from a series of sequential values.

27. The method of claim 22, performed by a base station, and wherein transmitting transmits the packet to a core network.

28.-35. (canceled)
